(19) United States
(12) Patent Application Publication
(10) Pub. No.: US 2005/0035060 A1
(43) Pub. Date: Feb. 17, 2005

(54) Process for purifying glyphosate solutions by nanofiltration

(76) Inventors: Jorge Gustavo Vigil, Buenos Aires (AR); Salvador Luis Parrotino, Buenos Aires (AR); Marcelo Adrian Lembo, Buenos Aires (AR)

Correspondence Address: JACOBSON HOLMAN PLLC, 400 SEVENTH STREET N.W., SUITE 600, WASHINGTON, DC, 20004, US

(21) Appl. No.: 10/743,465

(22) Filed: Dec. 23, 2003

(30) Foreign Application Priority Data
Mar. 28, 2003 (AR) P 03 01 01119

(51) Int. Cl. B01D 61/00

(52) U.S. Cl. 210/639; 210/651; 210/653; 210/805

(57) ABSTRACT

A process to purify Glyphosate solutions (N-phosphonomethylglycine) originated from Glyphosate synthesis by oxidation of N-phosphonomethylimidodiacetic acid and containing formaldehyde and formic acid as main impurities, comprising the steps of: providing an initial solution of Glyphosate with a Glyphosate concentration ranging between 0.1 and 3% w/v, a formaldehyde concentration ranging between 0.5 and 1% w/v, and a formic acid concentration ranging between 0.1 and 0.6% w/v; adjusting the pH of the said initial Glyphosate solution to a value ranging between 2.5 and 3.5 with a base selected from alkylamine, ammonium hydroxide, sodium, or potassium hydroxide; submitting said solution to nanofiltration, at a temperature ranging between 10 and 35° C. and a pressure ranging between 25 and 35 Kg/cm²; carrying out said nanofiltration through at least one nanofiltration membrane; recovering the concentrated Glyphosate solution; and discarding the permeate solution.

### BACKGROUND OF THE INVENTION

1. Field of the Invention

This invention refers to a process to purify Glyphosate solutions (N-phosphonomethylglycine) by nanofiltration. In particular, the process under this invention refers to the purification of aqueous solutions obtained from glyphosate synthesis and containing formaldehyde and formic acid as main impurities.

2. Description of the Prior Art

Nanofiltration is a physical operation which includes, in general terms, the treatment of aqueous solutions by forcing the water through a porous membrane. The membranes useful as nanofilters allow the water molecules to pass through the pores of the membrane together with small organic and inorganic molecules.

Larger organic and inorganic molecules are rejected by the nanofilter and remain in the initial solution.

Consequently, nanofilters have the capacity of removing most inorganic salts and a great percentage of the dissolved organic matter.

This property has been used, for example, to purify swimming pool water (U.S. Pat. No. 5,234,583) eliminating calcium, magnesium, and sodium salts, and other organic substances which are precursors for fungi, viruses, and bacteria.

The prefix “nano” means 10⁻⁹, so that 1 n (nanometer) is equivalent to 10⁻⁹ meters and also equivalent to 10 angstroms.

Consequently, the membranes useful for nanofiltration will be those with a pore diameter on the order of 10 angstroms.

The so-called NF-70 membranes, manufactured by FilmTec, a subsidiary of Dow Chemical Company, are representative of this type of membranes useful for nanofiltration.

Said membranes have the property of preventing the passage of all molecular species with a diameter equal to or larger than 10 angstroms.

This diameter is consistent with a molecular weight of approximately 200.

The rejection of molecular species with molecular weights under 200 will depend on the size of the species, its structural geometry, ionic charge, and affinity for the composition of the membrane.

Nanofiltration processes may conveniently operate at pressures on the order of 500 kPa (approx. 70 psi) or higher if we wish to increase the flow of liquid filtered.

### SUMMARY OF THE INVENTION

Unexpectedly, it has been discovered that the nanofiltration process may be used successfully to eliminate or reduce the content of certain impurities which are normally contained in Glyphosate solutions obtained from solutions of PMIDA (N-phosphonomethyliminodiacetic acid).

Because of the simplicity of the process under this invention, this purification method offers certain advantages versus other physical or chemical processes because it does not introduce any other element in the solutions to be purified.

The impurities referred to are formaldehyde and formic acid.

The literature mentions the use of nanofiltration membranes to eliminate other types of impurities such as, for example, the sulfates and phosphates present in N-methyl glyphosate and glyphosate solutions with a pH of 1.4 (U.S. Pat. No. 6,232,494).

Patent U.S. Pat. No. 5,234,583 indicates the use of the NF 70 membrane (FILMTEC Dow) to remove calcium and magnesium sulfate from a solution of sodium chloride.

The process which has been studied, may also be applied to processes of recovery of water contaminated with Glyphosate or effluent from the manufacturing process with the same characteristics.

The presence of formaldehyde and formic acid in Glyphosate solutions affect its quality in the concentration stage (water evaporation) even under very mild conditions (low temperatures and pressures), generating new impurities and carbon dioxide.

This degradation is also manifested in the presence of certain protector agents (sulfite).

By applying the nanofiltration to Glyphosate solution with concentrations between 0.1 and 3%, with a formaldehyde content of 0.5 to 1% and formic acid 0.1 to 0.6%, solutions with up to approximately 8% Glyphosate were obtained, eliminating between 50% and 95% of said impurities.

For the study, equipment with a single membrane, or equipment with several membranes placed in series was employed.

The identification and providers of the membranes are:
1) FILMTEC (DOW): NF 40, NF 70, NF 90, etc.
2) OSMONICS, Inc.: AK 4040 F.

The pH of the solutions to be purified preferably ranges between 2.5 and 3.5. The pH may be adjusted with alkylamine, ammonium hydroxide, sodium, or potassium hydroxide.

The temperature of the solution preferably ranges between 10 and 35° C.

The working pressure preferably ranges between 25 and 35 Kg/cm² when equipment with a single membrane is used, and the solution containing Glyphosate is recirculated through the membrane, separating and discarding the solution containing the impurities (permeate).

After successive recycling, a Glyphosate concentration on the order of 8% is reached, with a Glyphosate recovery on the order of 98%.

If the equipment used has several membranes (12) located in series, the operation is conducted in continuous cycle.

### DESCRIPTION OF THE PREFERRED EMBODIMENTS

### EXAMPLE 1

Nanofilter: One NF 70 Membrane

Operation: Batch

The pH of an initial Glyphosate solution is adjusted (with the concentrations and volume indicated below) to a value of 3.0 with monoisopropylamine. Next, the solution is circulated through a column containing the 4-inch nanofiltration membrane (7.6 m²/membrane), under a temperature of approximately 25° C. under an initial working pressure of 25 Kg/cm².

The solution with a higher Glyphosate concentration is recovered, discarding the permeate solution containing the impurities.

The concentrated solution is circulated again through the membrane increasing the working pressure.

The cycles are repeated until a working pressure of 35 Kg/ cm² is reached.

Glyphosate concentration in the solution recovered under these conditions is approximately 8%.

The conditions of the test were the following:

Initial solution:

Volume: 1,000 L

Glyphosate: 3% w/v

Formaldehyde: 0.7% w/v

Formic Acid: 0.3% w/v

Final solution:

Volume: 375 L

Glyphosate: 7.9% w/v

Formaldehyde: 0.7% w/v

Formic Acid: 0.3% w/v

Results:

Glyphosate Recovery: 98.75%

Formaldehyde Elimination: 62.5%

Formic Acid Elimination: 62.5%

### EXAMPLE 2

In this test, the technique in Example 1 was repeated, starting with a more diluted Glyphosate solution.

The conditions were the following:

Initial solution:

Volume: 1,000 L

Glyphosate: 1% w/v

Formaldehyde: 0.6% w/v

Formic Acid: 0.4% w/v

Final solution:

Volume: 127 L

Glyphosate: 7% w/v

Formaldehyde: 0.7% w/v

Formic Acid: 0.5% w/v

Results:

Glyphosate Recovery: 99.06%

Formaldehyde Elimination: 85.2%

Formic Acid Elimination: 84.1%

### EXAMPLE 3

Nanofilter: 12 NF 70 membranes

Operation: continuous

The operating flow conditions were adjusted so as to work under a pressure of 35 Kg/cm² in the last membrane.

The conditions were the following:

Initial solution:

Volume: 10,000 L

Glyphosate: 0.1% w/v Formaldehyde: 0.5% w/v Formic Acid: 0.2% w/v

Final solution:

Volume: 816 L Glyphosate: 1.2% w/v Formaldehyde: 0.3% w/v Formic Acid: 0.2% w/v

Results:

Glyphosate Recovery: 97.92%

Formaldehyde Elimination: 95.1%

Formic Acid Elimination: 91.8%

OVERALL RESULTS

The impurities (formaldehyde and formic acid) generated in the production of Glyphosate by oxidation of PMIDA interact during the concentration process, degrading the Glyphosate and generating new impurities.

By applying the process described before the concentration of the Glyphosate solutions, the inconveniences mentioned are reduced or avoided by eliminating the said impurities.

Glyphosate recovery factor is on the order of 98%, while with the process under this invention it has been demonstrated that between 50% and 95% of the initial formaldehyde and formic acid content are eliminated.

1. A process to purify Glyphosate solutions ((N-phosphonomethylglycine) obtained from the synthesis of Glyphosate by oxidation of N-phosphonomethylimidodiacetic acid and containing formaldehyde and formic acid as main impurities, comprising the steps of:
providing an initial solution of Glyphosate with a Glyphosate concentration ranging between 0.1% and 3% w/v, a formaldehyde concentration ranging between 0.5% and 1% w/v, and a formic acid concentration ranging between 0.1% and 0.6% w/v;
adjusting the pH of the said initial Glyphosate solution to a value ranging between 2.5 and 3.5 with a base selected from alkylamine, ammonium hydroxide, sodium, or potassium hydroxide;
submitting said solution to nanofiltration at a temperature ranging between 10° C. and 35° C. and a pressure ranging between 25 and 35 Kg/cm²;
carrying out said nanofiltration through at least one nanofiltration membrane;
recovering the concentrated Glyphosate solution containing more than 97% of Glyphosate from the initial solution with a Glyphosate concentration of approximately 8%; and
discarding the permeate solution containing between 50% and 95% of formaldehyde and formic acid present in said initial solution.

2. The process in accordance with claim 1, wherein:
the pH of the initial Glyphosate solution is adjusted with an alkylamine;
the solution is circulated through a column containing the 4-inch nanofiltration membrane (7.6 m²/membrane) at a temperature of 25° C. under an initial working pressure of 25 Kg/cm²;
the solution with a higher concentration of Glyphosate is recovered, discarding the permeate solution which contains the impurities;
the concentrated solution is recirculated through the membrane under increased working pressure; and
the recirculation is repeated until a working pressure of 35 Kg/cm² is obtained and the concentrated Glyphosate solution is recovered.

3. The process in accordance with claim 1, wherein the nanofiltration is done continuously using 12 nanofiltration membranes placed in series, and the operating flow conditions are adjusted so that in the last membrane the working pressure is 35 Kg/cm².

4. The process in accordance with claim 1, wherein the pH of the initial Glyphosate solution is adjusted with an alkylamine.

5. The process in accordance with claim 1, wherein the solution is circulated through a column containing the 4-inch nanofiltration membrane (7.6 m²/membrane) at a temperature of 25° C. under an initial working pressure of 25 Kg/cm².

6. The process in accordance with claim 1, wherein the concentrated solution is recirculated through the membrane under an increased working pressure and the recirculation is repeated until a working pressure of 35 Kg/cm² is obtained and the concentrated Glyphosate solution is recovered.
